(19) United States
(12) Patent Application Publication
(10) Pub. No.: US 2015/0219932 A1
(43) Pub. Date: Aug. 6, 2015

(54) GLASSES AND TEMPLE UNIT THEREOF

(71) Applicant: LIN YUAN CHEN, TAINAN CITY (TW)

(72) Inventor: LIN YUAN CHEN, TAINAN CITY (TW)

(21) Appl. No.: 14/174,000

(22) Filed: Feb. 6, 2014

(51) Int. Cl. G02C 11/02; G02C 5/14

(52) U.S. Cl. CPC G02C 11/02; G02C 5/14

(57) ABSTRACT

A temple unit of a pair of glasses includes at least a temple, at least an adornment and at least a fastener. The temple has an adornment socket. The adornment is disposed in the adornment socket. The fastener is rotatable around the temple and fastens the adornment to the adornment socket.

### BACKGROUND OF THE INVENTION

1. Field of the Invention

The invention relates to a pair of glasses and, in particular, to a pair of glasses and a temple unit thereof.

2. Description of the Prior Art

The lens device (or glasses), such as sunglasses, working goggles, nearsighted eyeglasses, farsighted spectacles, presbyopia eyeglasses or the like, have become an indispensable appliance, helping people's living a lot. So, how to enhance the added value and taste of the glasses is an important project for the industry.

Therefore, it is an important subject to provide a pair of glasses equipped with an innovative structure so as to be enhanced in added value and taste and the using efficiency and product competitiveness can be thus increased a lot.

### SUMMARY OF THE INVENTION

In view of the foregoing subject, an objective of the invention is to provide a pair of glasses equipped with an innovative structure so as to be enhanced in added value and taste and the using efficiency and product competitiveness can be thus increased a lot.

To achieve the above objective, a temple unit of a pair of glasses according to the invention includes at least a temple, at least an adornment and at least a fastener. The temple has an adornment socket. The adornment is disposed in the adornment socket. The fastener is rotatable around the temple and fastens the adornment to the adornment socket.

In one embodiment, the temple further includes a first position limiting portion disposed adjacent to the adornment socket, the fastener includes a second position limiting portion, and the second position portion is coupled to the first position limiting portion.

In one embodiment, the first position limiting portion includes two pillars, and the second position limiting portion includes a recess.

In one embodiment, the adornment socket has a curved shape, a polygonal shape or their combination.

In one embodiment, the adornment has two opposite surfaces and at least one of the surfaces has at least a color.

In one embodiment, the fastener is disposed to the temple pivotally.

In one embodiment, the adornment socket has a flange and the adornment is coupled to the flange.

In one embodiment, the adornment adheres to the adornment socket, or the fastener, or the adornment socket and the fastener.

In one embodiment, the adornment includes a first engaging portion and the adornment socket includes a second engaging portion, and the first engaging portion is coupled with the second engaging portion.

In one embodiment, the temple unit further comprises a protecting element disposed to the adornment socket, and the adornment is disposed between the protecting element and the fastener.

To achieve the above objective, a pair of glasses according to the invention comprises at least one of the above-mentioned temple units and at least a frame connected with the temple.

As mentioned above, the glasses and the temple unit of the invention have an adornment socket, an adornment is disposed to the adornment socket, and the fastener is rotatable around the temple to fasten the adornment to the adornment socket. By the cooperation of the adornment and the adornment socket, the appearance of the glasses can show variety and also can display particular information and the added value and taste of the glasses can be enhanced. Besides, the using efficiency and product competitiveness can be increased a lot. Moreover, by the disposition of the fastener, the adornment can be easily replaced. As long as the user rotates the fastener around the temple, the adornment can be detached and a new one can be installed.

### BRIEF DESCRIPTION OF THE DRAWINGS

FIG. 1 is a schematic exploded diagram of a pair of glasses and a temple unit thereof according to an embodiment of the invention;

FIG. 2 is a schematic diagram of the glasses and the temple unit in FIG. 1;

FIG. 3 is a schematic sectional diagram of the glasses and the temple unit in FIG. 1;

FIG. 4 is a schematic diagram showing an operation of the glasses and the temple unit in FIG. 1; and

FIGS. 5 to 7 are schematic diagrams of some variations of the glasses and the temple unit thereof according to an embodiment of the invention.

### DETAILED DESCRIPTION OF THE INVENTION

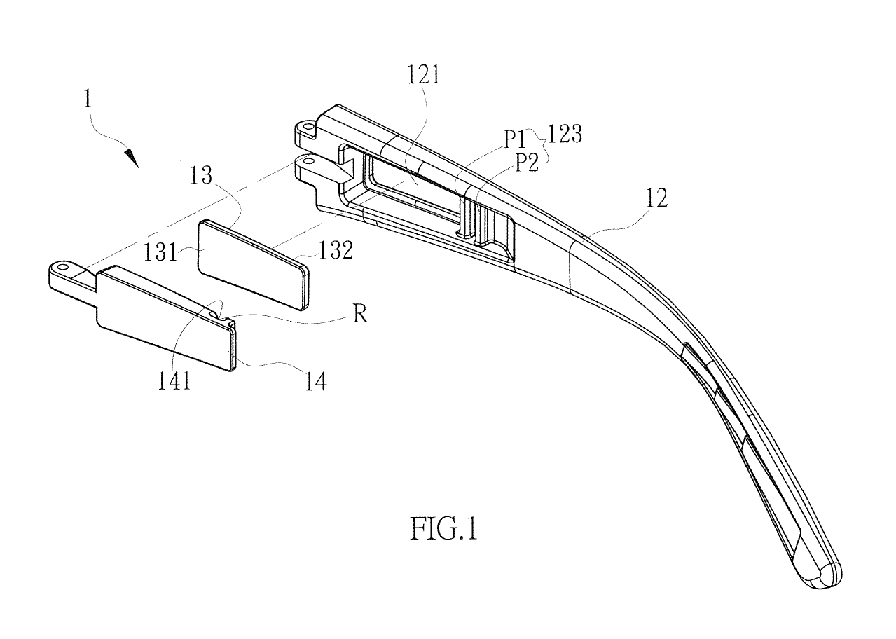

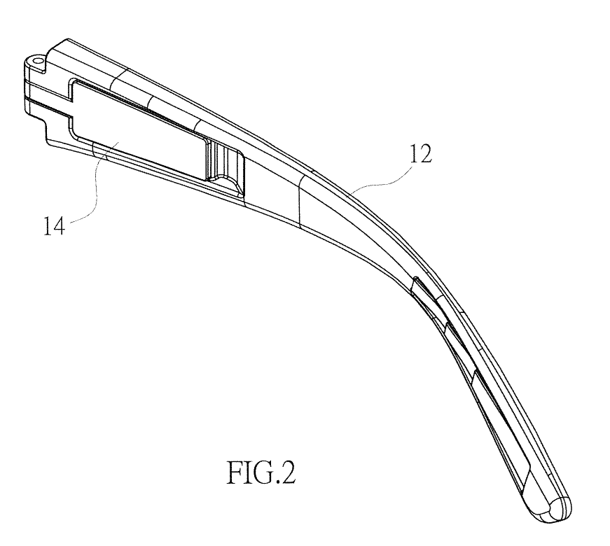

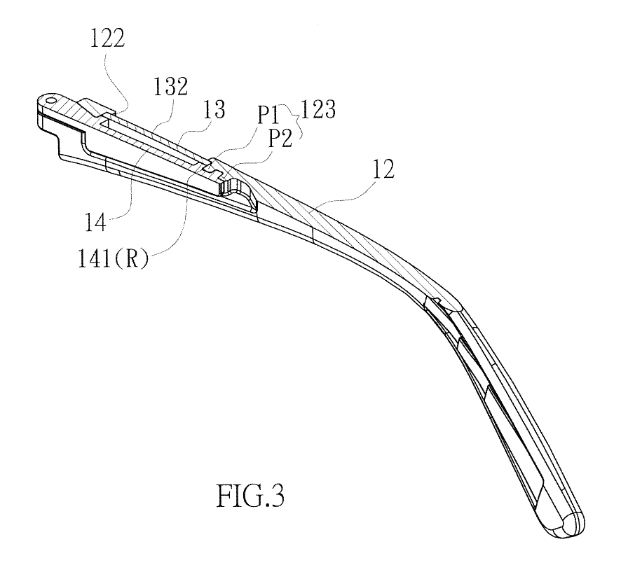

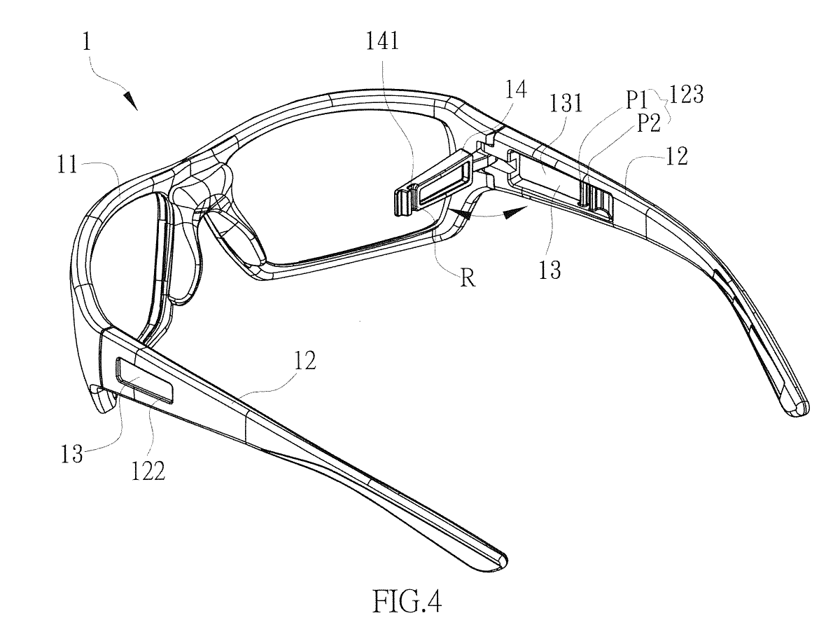

FIG. 1 is a schematic exploded diagram of a pair of glasses 1 and a temple unit thereof according to an embodiment of the invention, FIG. 2 is a schematic diagram of the glasses 1 and the temple unit in FIG. 1, FIG. 3 is a schematic sectional diagram of the glasses 1 and the temple unit in FIG. 1, and FIG. 4 is a schematic diagram showing an operation of the glasses 1 and the temple unit in FIG. 1. As shown in FIGS. 1 to 4, the glasses 1 of this embodiment include at least a frame 11, at least a temple 12, at least an adornment 13 and at least a fastener 14. The temple unit includes the temple 12, the adornment 13 and the fastener 14. In the invention, the glasses 1 is not limited in type and shape, and the glasses 1 can be a pair of sunglasses, working goggles, nearsighted eyeglasses, farsighted spectacles, presbyopia eyeglasses, snow goggles, or the like.

In this embodiment, the glasses 1 have two frames 11 connected to each other for example. The frames 11 can be two elements connected together or be originally made as one piece. In other embodiments, the glasses can have a single frame 11 and the single frame 11 covers the range of the two eyes of the user. The shape of the frame 11 is not limited in this embodiment, and the frame 11 can have a curved shape, a polygonal shape or their combination for example. The glasses 1 are also not limited in material, which can include metal or plastic material.

In this embodiment, the glasses 1 have two temples 12 for example. The temples 12 are connected to the frames 11, respectively. Herein, the temple 12 is disposed to the frame 11 pivotally. In other embodiments, the temple 12 can be fixed to the frame 11 and can not be rotated around the frame 11. The shape and material of the temple 12 are also not limited in this embodiment. The temple 12 includes an adornment socket 121, which is used to contain the adornment 13. The adornment 121 can have a polygonal shape, a curved shape or their combination for example. The adornment socket 121 can be adjusted according to the shape of the adornment 13, and thus has a trademark logo or a particular pattern.

In this embodiment, the glasses 1 have two adornments 13 for example. The adornment 13 is disposed to the adornment socket 121. The adornment 13 has a polygonal shape, a curved shape or their combination for example. The adornment 13 can be a trademark logo or have a particular pattern. The adornment 13 has two opposite surfaces 131, 132, and at least one of the surfaces has at least a color to show beauty or colorfulness. For example, the surface 132 facing outside has a color. The adornment 13 can be connected to the adornment socket 121 by locking, engaging, adhering, embedding or other methods, and herein is connected to the adornment socket 121 by adhering for example. In this embodiment, the adornment socket 121 has a flange 122, and the adornment 13 is coupled to the flange 122. Herein for example, the adornment 13 adheres to the flange 122.

In this embodiment, the glasses have two fasteners for example. The fastener 14 is rotatable around the temple 12 and fastens the adornment 13 to the adornment socket 121. Herein, the fastener 14 is disposed to the temple 12 pivotally. In this embodiment, the fastener 14, the temple 12 and the frame 11 are disposed around the same rotation axis, but however, they can be disposed around different rotation axes in other embodiments. In this embodiment, the temple 12 further includes a first position limiting portion 123 disposed adjacent to the adornment socket 121, the fastener 14 includes a second position limiting portion 141, and the second position portion 141 is coupled to the first position limiting portion 123. Herein, the first position limiting portion 123 includes two pillars P1 and P2, and the second position limiting portion 141 includes a recess R. The recess R is locked by the pillars P1 and P2, and the fastener 14 can fasten the adornment 13 to the adornment socket 121 thereby. In other embodiments, the first position limiting portion can include a single pillar and the second position limiting portion can be tightly fit to the pillar of the first position limiting portion. As an embodiment, the adornment 13 may not adhere to the adornment socket 121 but to the fastener 14, or may adhere to both of the adornment socket 121 and the fastener 14, and therefore the connection strength can be enhanced.

As shown in FIG. 4, the user can unfasten the fastener 14 to take the adornment 13 out and put a new adornment 13 into the adornment socket 121, and then fastens the fastener 14.

The glasses 1 of this embodiment can have many variations, and some of them are illustrated as below.

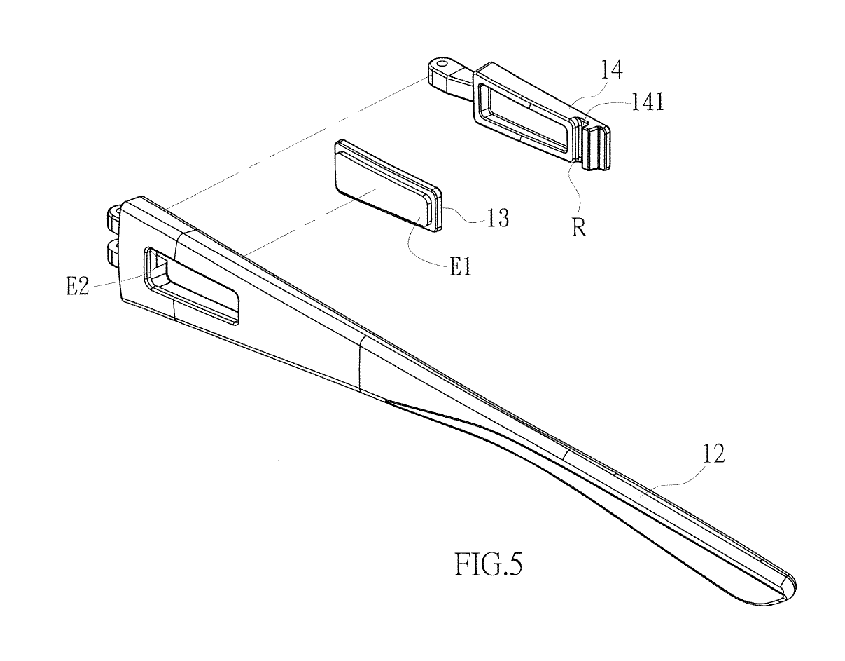

As shown in FIG. 5, the adornment 13 includes a first engaging portion E1, and the adornment socket 121 includes a second engaging portion E2. The first engaging portion E1 is coupled with the second engaging portion E2 in order to further enhance the connection strength between the adornment 13 and the adornment socket 121. Herein for example, the first engaging portion E1 is a protrusion and the second engaging portion E2 is a corresponding indentation.

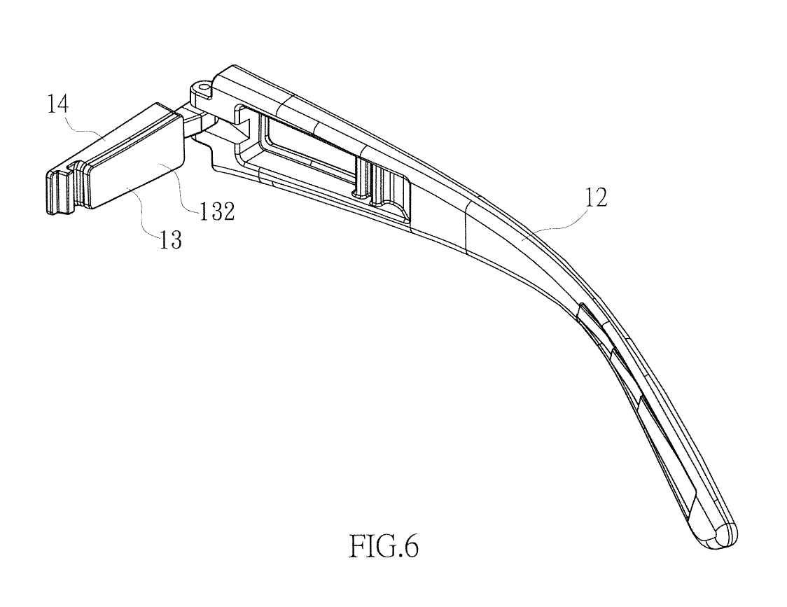

As shown in FIG. 6, the adornment 13 adheres to the fastener 14 so that the user can conveniently install the adornment 13 to the adornment socket 121. In this embodiment, the side of the adornment 13 facing the adornment socket 121 can have stickiness to adhere to the adornment socket 121.

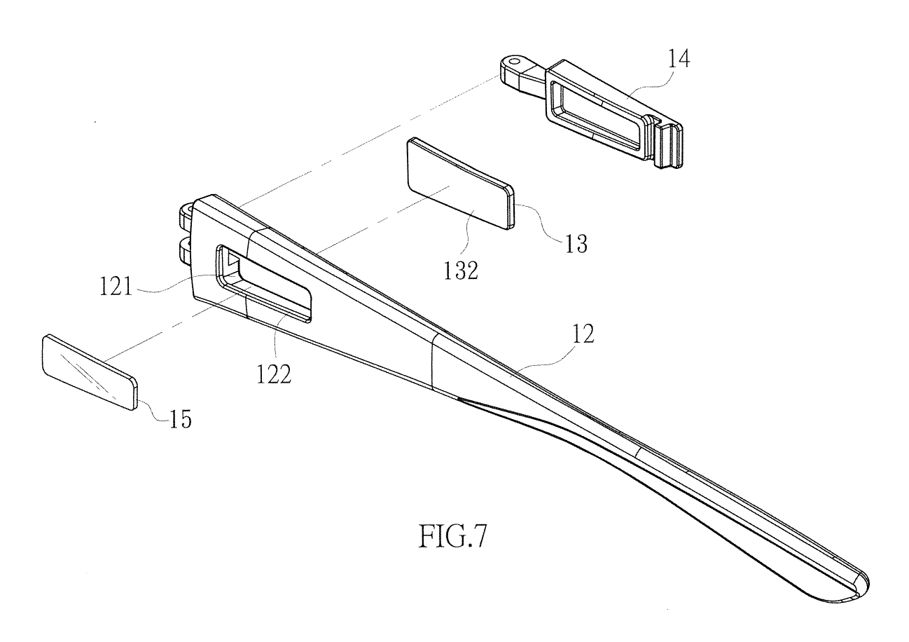

As shown in FIG. 7, the temple unit of the glasses 1 can further include a protecting element 15, which can be disposed to the adornment socket 121. Besides, the adornment 13 is disposed between the protecting element 15 and the fastener 14. The protecting element 15 can protect the adornment 13 from contamination or damage. The protecting element 15 can be transparent or semiopaque, or have a color or no color. The adornment 13 also can adhere to the protecting element 15.

In summary, the glasses and the temple unit of the invention have an adornment socket, an adornment is disposed to the adornment socket, and the fastener is rotatable around the temple to fasten the adornment to the adornment socket. By the cooperation of the adornment and the adornment socket, the appearance of the glasses can show variety and also can display particular information and the added value and taste of the glasses can be enhanced. Besides, the using efficiency and product competitiveness can be increased a lot. Moreover, by the disposition of the fastener, the adornment can be easily replaced. As long as the user rotates the fastener around the temple, the adornment can be detached and a new one can be installed.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A temple unit of a pair of glasses, comprising:
at least a temple, having an adornment socket;
at least an adornment disposed in the adornment socket; and
at least a fastener being rotatable around the temple and fastening the adornment to the adornment socket.

2. The temple unit as recited in claim 1, wherein the temple further includes a first position limiting portion disposed adjacent to the adornment socket, the fastener includes a second position limiting portion, and the second position portion is coupled to the first position limiting portion.

3. The temple unit as recited in claim 2, wherein the first position limiting portion includes two pillars, and the second position limiting portion includes a recess.

4. The temple unit as recited in claim 1, wherein the adornment socket has a curved shape, a polygonal shape or their combination.

5. The temple unit as recited in claim 1, wherein the adornment has two opposite surfaces and at least one of the surfaces has at least a color.

6. The temple unit as recited in claim 1, wherein the fastener is disposed to the temple pivotally.

7. The temple unit as recited in claim 1, wherein the adornment socket has a flange and the adornment is coupled to the flange.

8. The temple unit as recited in claim 1, wherein the adornment adheres to the adornment socket, or the fastener, or the adornment socket and the fastener.

9. The temple unit as recited in claim 1, wherein the adornment includes a first engaging portion and the adornment socket includes a second engaging portion, and the first engaging portion is coupled with the second engaging portion.

10. The temple unit as recited in claim 1, further comprising:
a protecting element disposed to the adornment socket, wherein the adornment is disposed between the protecting element and the fastener.

11. A pair of glasses, comprising:
at least a temple unit as recited in claim 1; and
at least a frame connected with the temple.

12. The glasses as recited in claim 11, wherein the temple further includes a first position limiting portion disposed adjacent to the adornment socket, the fastener includes a second position limiting portion, and the second position portion is coupled to the first position limiting portion.

13. The glasses as recited in claim 12, wherein the first position limiting portion includes two pillars, and the second position limiting portion includes a recess.

14. The glasses as recited in claim 11, wherein the adornment socket has a curved shape, a polygonal shape or their combination.

15. The glasses as recited in claim 11, wherein the adornment has two opposite surfaces and at least one of the surfaces has at least a color.

16. The glasses as recited in claim 11, wherein the fastener is disposed to the temple pivotally.

17. The glasses as recited in claim 11, wherein the adornment socket has a flange and the adornment is coupled to the flange.

18. The glasses as recited in claim 11, wherein the adornment adheres to the adornment socket, or the fastener, or the adornment socket and the fastener.

19. The glasses as recited in claim 11, wherein the adornment includes a first engaging portion and the adornment socket includes a second engaging portion, and the first engaging portion is coupled with the second engaging portion.

20. The glasses as recited in claim 11, wherein the temple unit further comprises:
a protecting element disposed to the adornment socket, wherein the adornment is disposed between the protecting element and the fastener.
